(19) United States
(12) Patent Application Publication
(10) Pub. No.: US 2010/0290459 A1
(43) Pub. Date: Nov. 18, 2010

(54) TRANSMISSION APPARATUS AND METHOD FOR PACKET DATA OF VARIABLE LENGTH, AND RECEIVING APPARATUS

(75) Inventors: Nam-kyung Lee, Daejeon-si (KR); Dae-ig Chang, Daejeon-si (KR); Ho-jin Lee, Daejeon-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/812,989

(22) PCT Filed: Sep. 11, 2009
(86) PCT No.: PCT/KR09/05191

§ 371 Date: Jul. 15, 2010

(30) Foreign Application Priority Data
Sep. 23, 2008 (KR) 10-2008-0093234

(51) Int. Cl. H04L 12/56

(52) U.S. Cl. 370/389

(57) ABSTRACT

A variable length packet data transmission apparatus and method are provided. The variable length packet data transmission apparatus using a variable length packet transmission technique includes a data transmitter generating synchronization information for synchronizing data communication with a data receiving apparatus, including the generated synchronization information in transmission data to be transmitted according to a variable length packet transmission technique, and transmitting the transmission data including the synchronization information to the data receiving apparatus, and a data receiver receiving the transmission data including synchronization information from a data transmission apparatus, reconstructing the synchronization information included in the received transmission data, and performing synchronization with the data transmission apparatus using the reconstructed synchronization information.

### TECHNICAL FIELD

The present invention relates to satellite communication technology, and more particularly, a variable length packet data transmission apparatus and method.

### BACKGROUND ART

High-speed two-way satellite communication systems using a satellite network employ a digital video broadcasting satellite (DVB-S) technique based on time division multiplexing (TDM) in a forward link, and a digital video broadcasting with return channel via satellite (DVB-RCS) technique based on time division multiple access (TDMA) in a reverse link. In such satellite broadcasting and communication systems, in order to reconstruct a clock of a receiving side, program clock reference (PCR) information generated using a reference clock of a hub station is included in a moving picture experts group 2 transport stream (MPEG2-TS) having a certain program ID (PID) and is periodically transmitted.

The receiving side reconstructs a reference clock of the hub station using the received PCR value and a PCR cycle, and uses the reconstructed reference clock as its reference clock. In such a satellite communication system, a value included in a PCR field of the MPEG standard for clock and timing synchronization of the reverse link is referred to as a network clock reference (NCR).

The digital video broadcasting (DVB) standard employs an MPEG-TS-based data transmission technique, but next generation standards such as DVB-S2 are required to support a variable length packet transmission technique which is also called generic stream encapsulation.

The variable length packet transmission technique provides for more flexible transmission than existing techniques. However, since it does not suggest a scheme for synchronization between a transmitting end and a receiving end, which is necessary for two-way broadcasting and communication, two-way communication is impossible. Therefore, a scheme for further improving transmission is required.

### DISCLOSURE OF INVENTION

### Technical Problem

The present invention provides a data transmission apparatus and method which enable two-way communication in a satellite communication network to which a variable length packet transmission technique is applied.

### Technical Solution

According to an exemplary aspect, there is provided a variable length packet data transmission apparatus using a variable length packet transmission technique, the apparatus including a data transmitter generating synchronization information for synchronizing data communication with a data receiving apparatus, including the generated synchronization information in transmission data to be transmitted according to a variable length packet transmission technique, and transmitting the transmission data including the synchronization information to the data receiving apparatus and a data receiver receiving the transmission data including synchronization information from a data transmission apparatus, reconstructing the synchronization information included in the received transmission data, and performing synchronization with the data transmission apparatus using the reconstructed synchronization information.

According to another exemplary aspect, there is provided a data transmission apparatus complying with a variable length packet transmission technique, the apparatus including a synchronization information generator generating synchronization information for synchronizing data communication with a data receiving apparatus, a synchronization information inserting unit including the generated synchronization information in transmission data to be transmitted according to a variable length packet transmission technique, and a communicator transmitting the transmission data including the synchronization information to the data receiving apparatus.

According to still another exemplary aspect, there is provided a data receiving apparatus complying with a variable length packet transmission technique, the apparatus including a communicator receiving transmission data including synchronization information from a data transmission apparatus, a reconstructing unit reconstructing the synchronization information included in the received transmission data, and a synchronizer performing synchronization with the data transmission apparatus using the reconstructed synchronization information.

According to another exemplary aspect, there is provided a method for transmitting data according to a variable length packet transmission technique, the method including, at a data transmission apparatus, generating synchronization information, at the data transmission apparatus, including the generated synchronization information in transmission data to be transmitted according to the variable length packet transmission technique, and, at the data transmission apparatus, transmitting the transmission data including the synchronization information to a data receiving apparatus.

The method may further include, at the data receiving apparatus, receiving the transmission data including the synchronization information from the data transmission apparatus, at the data receiving apparatus, reconstructing the synchronization information included in the received transmission data, and, at the data receiving apparatus, performing synchronization with the data transmission apparatus using the reconstructed synchronization information.

The method may further include, at the data transmission apparatus, including error detection information used for detecting whether or not an error occurs in the transmission data and, at the data receiving apparatus, determining whether or not an error occurs in the received transmission data using the error detection information included in the received transmission data.

Additional features of the invention will be set forth in the description which follows, and in part will be apparent from the description, or may be learned by practice of the invention.

### ADVANTAGEOUS EFFECTS

According to exemplary embodiments of the present invention, since synchronization information can be transmitted, two-way communication is possible in the satellite communication network environment to which a variable length packet transmission technique is applied.

Overhead occurring in an MPE/MPEG-TS technique used in DVB-S or DVB-S2 systems can be reduced. Accordingly, throughput can be improved, and transmission efficiency can be improved due to an error correction function.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a data transmission apparatus according to an exemplary embodiment of the present invention;

FIG. 2 is a block diagram of a data transmission apparatus according to another exemplary embodiment of the present invention;

FIG. 3 is a block diagram of a data receiving apparatus according to an exemplary embodiment of the present invention; and

FIG. 4 is a flowchart illustrating a data transmission method according to an exemplary embodiment of the present invention.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

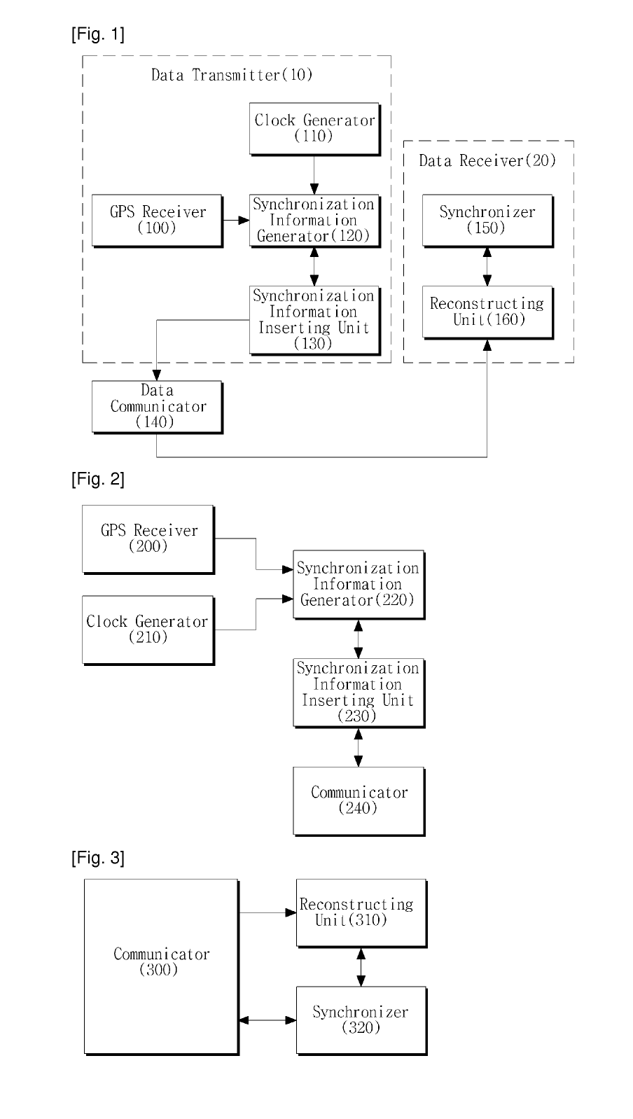

FIG. 1 is a block diagram of a data transmission apparatus according to an exemplary embodiment of the present invention.

The data transmission apparatus according to an exemplary embodiment of the present invention includes a data transmitter 10, a data receiver 20 and a data communicator 140.

The data communicator 140 transmits transmission data including synchronization information generated by a synchronization information inserting unit 130. In the present exemplary embodiment, the data communicator 140 is configured to include an antenna, and may be configured to transceive data via a satellite network according to the DVB-S2 standard. The data communicator 140 transmits transmission data output from the data transmitter 10 to an external data transmission apparatus which is in a receiving mode, and transfers transmission data received from an external data transmission apparatus which is in a transmitting mode to the data receiver 20.

The data transmitter 10 operates when the data transmission apparatus is in a transmitting mode, and includes a GPS receiver 100, a clock generator 110, a synchronization information generator 120, and a synchronization information inserting unit 130.

The GPS receiver 100 receives a GPS signal from a GPS satellite. In the present exemplary embodiment, the GPS receiver 100 receives a GPS signal which includes time information, speed information, and position information. The clock generator 110 generates a clock signal. In the present exemplary embodiment, the clock generator 110 may be realized by a typical clock generator or a typical clock generating circuit which generates a clock signal at a predetermined cycle.

The synchronization information generator 120 generates synchronization information. The synchronization information refers to information for synchronizing the data transmission apparatus with a data receiving apparatus for two-way data communication. In the present exemplary embodiment, the synchronization information generator 120 may generate the synchronization information using the time information included in the GPS signal received through the GPS receiver 100. In another exemplary embodiment, the synchronization information may be generated using a clock signal acquired from the clock generator 110.

The synchronization information inserting unit 130 acquires a data packet which is to be transmitted to the data receiving apparatus. The synchronization information inserting unit 130 inserts the synchronization information generated by the synchronization information generator 120 in the process of converting the data packet into a transmission data format according to a variable length packet transmission technique. In one exemplary embodiment, the synchronization information inserting unit 130 may insert or include the synchronization information in part of the transmission data and encapsulate it in the process of encapsulating the data packet, in the form of transmission data, using the GSE technique.

First, when a system is initialized, the synchronization information inserting unit 130 updates an information table including information necessary for encapsulation. Information necessary for constructing a packet includes MODCOD information. The information table including information necessary for encapsulation may include modulation format information, MODCOD information including coding rate information, address information of a physical interface using the MODCOD information, and information as to whether or not the physical interface is in use.

The synchronization inserting unit 130 monitors a counting state of a timer in order to periodically insert the synchronization information. The synchronization information inserting unit 130 determines whether or not a synchronization information insertion cycle comes up. When the synchronization information insertion cycle comes up, it is checked whether or not information regarding a modulation/demodulation method of packet data to be transmitted, that is, Data_MODCOD information, and Syn_MODCOD information which is information regarding modulation/demodulation for transmitting the synchronization information, are identical.

When the Data_MODCOD information and the Syn_MODCOD information are identical, packet encapsulation is performed by forming a baseband data packet so that the packet data to be transmitted and the synchronization information can be included in one baseband frame field. The encapsulation may be performed by adding a GSE header according to a GSE protocol. On the contrary, when the Data_MODCOD information and the Syn_MODCOD information are not identical, the encapsulation is performed by forming a separate baseband data packet according to information regarding each modulation/demodulation method.

When the packet data to be transmitted is not input, even though the synchronization information transmission cycle comes up, the synchronization information inserting unit 130 selects the Syn_MODCOD information for the synchronization information packet from the information table including information necessary for encapsulation. Preferably, the Syn_MODCOD information having the lowest efficiency is selected. The synchronization information may be inserted such that the GSE header is added to the synchronization information to form a GSE packet.

However, a method for inserting the synchronizing information into the packet data through the synchronization information inserting unit 130 is not limited to the above-described method and is interpreted to include various modifications.

The synchronization information inserting unit 130 may additionally encode information for error detection as transmission data. Therefore, since data transmission errors can be detected, data transmission efficiency can be improved.

The data receiver 20 operates when the data transmission apparatus is in a receiving mode and includes a synchronizer 150 and a reconstructing unit 160.

The reconstructing unit 160 interprets synchronization information included in transmission data received through the data communicator 140. In the present exemplary embodiment, the reconstructing unit 160 may decapsulate encapsulated transmission data to reconstruct the synchronization information. A method for reconstructing the synchronization information through the reconstructing unit 160 is not limited to the above-described method.

The synchronizer 150 performs synchronization with a data transmission apparatus which transmits a satellite DVB signal using the synchronization information reconstructed by the reconstructing unit 160. Accordingly, two-way communication with a data transmission apparatus can be performed through the data communicator 140 using synchronized signals.

FIG. 2 is a block diagram of a data transmission apparatus according to another exemplary embodiment of the present invention.

As shown in FIG. 2, the data transmission apparatus according to another exemplary embodiment of the present invention includes a GPS receiver 200, a clock generator 210, a synchronization information generator 220, a synchronization information inserting unit 230, and a communicator 240.

The GPS receiver 200 receives a GPS signal from a GPS satellite. In the present exemplary embodiment, the GPS receiver 200 receives a GPS signal which includes time information, speed information, and position information. The clock generator 210 generates a clock signal. In the present exemplary embodiment, the clock generator 210 may be realized by a typical clock generator or a typical clock generating circuit which generates a clock signal at a predetermined cycle.

The synchronization information generator 220 generates synchronization information. The synchronization information refers to information for synchronizing the data transmission apparatus with a data receiving apparatus for two-way data communication. In the present exemplary embodiment, the synchronization information generator 220 may generate the synchronization information using the GPS signal received through the GPS receiver 200. In another exemplary embodiment, the synchronization information may be generated using a clock signal acquired from the clock generator 210.

The synchronization information inserting unit 230 acquires a data packet which is to be transmitted to a data receiving apparatus. The synchronization information inserting unit 230 inserts the synchronization information generated by the synchronization information generator 220 in the process of converting the data packet into a transmission data format according to a variable length packet transmission technique. In one exemplary embodiment, the synchronization information inserting unit 230 may include the synchronization information in part of the transmission data and encapsulate it in the process of encapsulating the data packet, in the form of transmission data, using the GSE technique.

First, when a system is initialized, the synchronization information inserting unit 230 updates an information table including information necessary for encapsulation. Information necessary for constructing a packet includes MODCOD information. The information table including information necessary for encapsulation may include modulation format information, MODCOD information including coding rate information, address information of a physical interface using the MODCOD information, and information as to whether or not the physical interface is in use.

The synchronization inserting unit 230 monitors a counting state of a timer in order to periodically insert the synchronization information. The synchronization information inserting unit 230 determines whether or not a synchronization information insertion cycle comes up. When the synchronization information insertion cycle comes up, it is checked whether or not information regarding a modulation/demodulation method for packet data to be transmitted, that is, Data_MODCOD information, and Syn_MODCOD information which is information regarding modulation/demodulation for transmitting the synchronization information, are identical.

When the Data_MODCOD information and the Syn_MODCOD information are identical, packet encapsulation is performed by forming a baseband data packet so that the packet data to be transmitted and the synchronization information can be included in one baseband frame field. The encapsulation may be performed by adding a GSE header according to a GSE protocol. On the contrary, when the Data_MODCOD information and the Syn_MODCOD information are not identical, the encapsulation is performed by forming a separate baseband data packet according to information regarding each modulation/demodulation method.

When the packet data to be transmitted is not input even though the synchronization information transmission cycle comes up, the synchronization information inserting unit 230 selects the Syn_MODCOD information for the synchronization information packet from the information table including information necessary for encapsulation. Preferably, the Syn_MODCOD information having the lowest efficiency is selected. The synchronization information may be inserted such that the GSE header is added to the synchronization information to form a GSE packet.

However, a method for inserting the synchronizing information into the packet data through the synchronization information inserting unit 230 is not limited to the above-described method and is interpreted to include various modifications.

The synchronization information inserting unit 230 may additionally encode information for error detection as transmission data.

The communicator 240 transmits transmission data including the synchronization information generated by the synchronization information inserting unit 230. In the present exemplary embodiment, the communicator 240 is configured to include an antenna and may be configured to transmit data via a satellite network according to the DVB-S2 standard.

FIG. 3 is a block diagram of a data receiving apparatus according to an exemplary embodiment of the present invention.

The data receiving apparatus according to an exemplary embodiment of the present invention includes a communicator 300, a reconstructing unit 310, and a synchronizer 320.

In the present exemplary embodiment, the data receiving apparatus receives a satellite DVB signal through the communicator 300, and the data communicator 140 may be configured to perform data communication according to the DVB-S2 standard.

The reconstructing unit 310 interprets synchronization information included in transmission data received through the communicator 300. In the present exemplary embodiment, the reconstructing unit 310 may decapsulate encapsulated transmission data to reconstruct the synchronization information. A method for reconstructing the synchronization information through the reconstructing unit 310 is not limited to the above-described method.

The synchronizer 320 performs synchronization with a data transmission apparatus which transmits a satellite DVB signal using the synchronization information reconstructed by the reconstructing unit 310. Accordingly, two-way communication with the data transmission apparatus can be performed through the communicator 300 using synchronized signals.

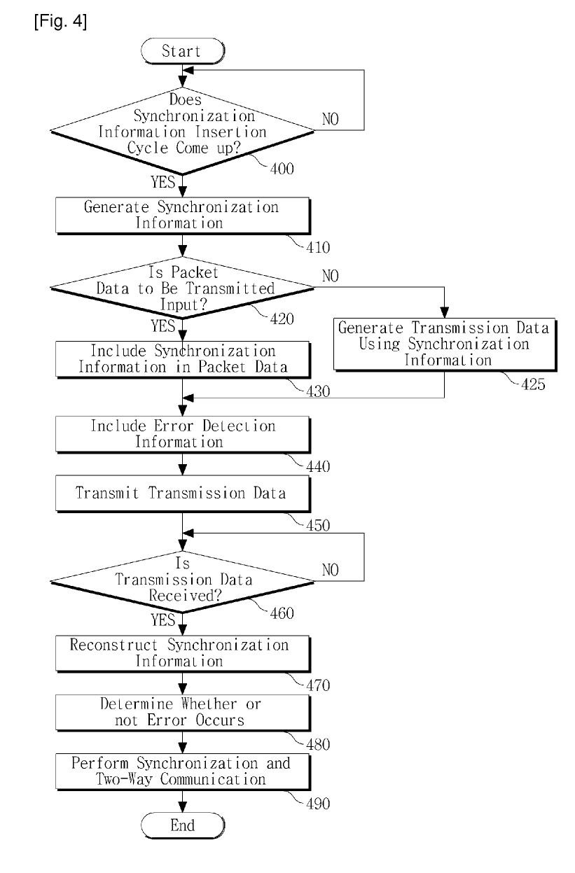

FIG. 4 is a flowchart illustrating a data transmission method according to an exemplary embodiment of the present invention.

First, when a system is initialized, the data transmission apparatus updates an information table including information necessary for encapsulation. Information necessary for constructing a packet includes MODCOD information. The information table including information necessary for encapsulation may include modulation format information, MODCOD information including coding rate information, address information of a physical interface using the MODCOD information, and information as to whether or not the physical interface is in use.

The data transmission apparatus monitors a counting state of a timer in order to periodically insert the synchronization information. When the synchronization information insertion cycle comes up (S400), the synchronization information is generated (S410).

The synchronization information refers to information for synchronizing the data receiving apparatus with the data transmission apparatus for two-way data communication. In the present exemplary embodiment, the synchronization information may be generated using a signal which is externally acquired, for example, a GPS signal received through a GPS satellite. In another exemplary embodiment, the synchronization information may be generated using a clock signal generated from a clock generator.

When packet data to be transmitted is input (S420), the synchronization information is inserted into or included in the packet data to form transmission data in a transmission data format (S430). In the present exemplary embodiment, the transmission data may be generated by adding a GSE header using a GSE protocol. However, a method for forming the transmission data is not limited to the above-described method.

On the contrary, when the packet data to be transmitted is not input even though the synchronization information insertion cycle comes up, transmission data including the synchronization information is generated (S425). In order to determine whether or not a data transmission error occurs, error detection information is further included (S440). Therefore, since it can be determined whether or not a data transmission error occurs, data transmission efficiency can be improved.

The generated transmission data is transmitted via the satellite communication network (S450).

The data receiving apparatus receives the transmission data including the synchronization information from the data transmission apparatus (S460). When the transmission data is received, the data receiving apparatus reconstructs the synchronization information from the received transmission data (S470). At this time, the error detection information included in the transmission data is interpreted to determine whether or not a data transmission error occurs (S480). Accordingly, since it can be determined whether or not a data transmission error occurs, data transmission efficiency can be improved.

The data receiving apparatus is synchronized with the data transmission apparatus using the interpreted synchronization information, so that two-way communication can be performed (S490).

The data transmission method described above can be implemented as a computer program. The computer program may be stored in a computer-readable recording medium, and read and executed by a computer to perform the above-described functions. Examples of the computer-readable recording medium include a magnetic recording medium and an optical recording medium.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A variable length packet data transmission apparatus using a variable length packet transmission technique, the apparatus comprising:
a data transmitter generating synchronization information for synchronizing data communication with a data receiving apparatus, including the generated synchronization information in transmission data to be transmitted according to a variable length packet transmission technique, and transmitting the transmission data including the synchronization information to the data receiving apparatus; and
a data receiver receiving the transmission data including synchronization information from a data transmission apparatus, reconstructing the synchronization information included in the received transmission data, and performing synchronization with the data transmission apparatus using the reconstructed synchronization information.

2. The variable length packet data transmission apparatus of claim 1, further comprising a clock generator generating a clock signal, wherein the data transmitter generates the synchronization information using the generated clock signal.

3. The variable length packet data transmission apparatus of claim 1, further comprising a GPS receiver receiving a GPS signal, wherein the data transmitter generates the synchronization information using GPS time information received from the GPS receiver.

4. The variable length packet data transmission apparatus of claim 1, wherein the data transmitter periodically includes the generated synchronization information in transmission data to be transmitted.

5. The variable length packet data transmission apparatus of claim 4, wherein when a synchronization information transmission cycle comes up, if there is no data input, the data transmitter generates and transmits transmission data including the synchronization information.

6. The variable length packet data transmission apparatus of claim 1, wherein the data transmitter further transmits error detection information used to detect whether or not an error occurs in the transmission data.

7. The variable length packet data transmission apparatus of claim 1, wherein the data receiver determines whether or not an error occurs in the received transmission data using error detection information included in the received transmission data.

8. A data transmission apparatus complying with a variable length packet transmission technique, the apparatus comprising:
a synchronization information generator generating synchronization information for synchronizing data communication with a data receiving apparatus;
a synchronization information inserting unit including the generated synchronization information in transmission data to be transmitted according to a variable length packet transmission technique; and
a communicator transmitting the transmission data including the synchronization information to the data receiving apparatus.

9. The data transmission apparatus of claim 8, further comprising a clock generator generating a clock signal, wherein the synchronization information generator generates the synchronization information using the generated clock signal.

10. The data transmission apparatus of claim 8, further comprising a GPS receiver receiving a GPS signal, wherein the synchronization information generator generates the synchronization information using GPS time information received from the GPS receiver.

11. The data transmission apparatus of claim 8, wherein the synchronization information inserting unit further transmits error detection information used to detect whether or not an error occurs in the transmission data.

12. A data receiving apparatus complying with a variable length packet transmission technique, the apparatus comprising:
a communicator receiving transmission data including synchronization information from a data transmission apparatus;
a reconstructing unit reconstructing the synchronization information included in the received transmission data; and
a synchronizer performing synchronization with the data transmission apparatus using the reconstructed synchronization information.

13. The data receiving apparatus of claim 12, wherein the reconstructing unit determines whether or not an error occurs in the received transmission data using error detection information included in the received transmission data.

14. A method for transmitting data according to a variable length packet transmission technique, the method comprising:
at a data transmission apparatus, generating synchronization information;
at the data transmission apparatus, including the generated synchronization information in transmission data to be transmitted according to the variable length packet transmission technique; and
at the data transmission apparatus, transmitting the transmission data including the synchronization information to a data receiving apparatus.

15. The method of claim 14, further comprising:
at the data receiving apparatus, receiving the transmission data including the synchronization information from the data transmission apparatus;
at the data receiving apparatus, reconstructing the synchronization information included in the received transmission data; and
at the data receiving apparatus, performing synchronization with the data transmission apparatus using the reconstructed synchronization information.

16. The method of claim 15, further comprising:
at the data transmission apparatus, including error detection information used for detecting whether or not an error occurs in the transmission data; and
at the data receiving apparatus, determining whether or not an error occurs in the received transmission data using the error detection information included in the received transmission data.

17. The method of claim 14, wherein, in the including of the synchronization information, the synchronization information is periodically included in the transmission data.
